(19) United States
(12) Patent Application Publication
(10) Pub. No.: US 2013/0035000 A1
(43) Pub. Date: Feb. 7, 2013

(54) SOCKET CONNECTOR HAVING CONSTRAINING PLATE FORMING FINAL CONTACTING POINT OF CONTACT TERMINAL

(71) Applicant: ALEX LON AN, Chandler, AZ (US)

(72) Inventor: ALEX LON AN, Chandler, AZ (US)

(73) Assignee: HON HAI PRECISION INDUSTRY CO., LTD., New Taipei (TW)

(21) Appl. No.: 13/198,668

(22) Filed: Aug. 4, 2011

(51) Int. Cl. H01R 24/28

(52) U.S. Cl. 439/660

(57) ABSTRACT

A socket connector includes a socket body, a cover located above the socket body, and a plurality of contacts. Each contact has a base portion retained in the socket body and a slanting resilient arm extending through the cover with a contacting end extending beyond an upper surface of the cover.

### BACKGROUND OF THE INVENTION

1. Field of the Invention

The present invention relates to a socket connector, and more particularly to a socket connector having a constraining plate forming a plurality of contact engaging portions through preformed and inclined through holes.

2. Description of Related Art

An electronic package, such as a CPU (Central Processing Unit), is generally coupled with a system via a socket connector mounted on a mother board. A typical socket connector is disclosed in U.S. Pat. No. 6,908,313 which is issued to William Walkup et al., on Jun. 21, 2005. The socket connector according to Walkup includes a socket body with a plurality of contacts received therein. The socket body includes a base and a plurality sidewalls extending from periphery of the base. The contacts are arranged in the base in an array and each includes a retaining section secured in the base and a slanting resilient arm extending beyond an upper surface of the base. The slanting arms of two adjacent contacts overlap with each in a vertical direction. When a CPU is downwardly placed toward contacts, the contacts deform under pressure and adjacent arms thereof move more closely to each other.

However, because the arms of the adjacent contacts are closely near each other, the risk of shorting is increased, especially in the case that the CPU is under over pressure by an external device.

In view of the above, an improved socket connector is desired to overcome the problems mentioned above.

### SUMMARY OF THE INVENTION

Accordingly, an object of the present invention is to provide a socket connector having a cover capable of preventing shorting of contacts.

According to one aspect of the present invention there is provided a socket connector which includes a socket body, a cover located above the socket body, and a plurality of contacts. Each contact has a base portion retained in the socket body and a slanting resilient arm extending through the cover with a contacting end extending beyond an upper surface of the cover.

Other objects, advantages and novel features of the invention will become more apparent from the following detailed description when taken in conjunction with the accompanying drawings, in which:

### BRIEF DESCRIPTION OF THE DRAWINGS

FIG. 1 is an assembled, perspective view of a socket connector in accordance with a preferred embodiment of the present invention;

FIG. 2 is an enlarged view of the part labeled with a circle line in FIG. 1;

FIG. 3 is a partial bottom view of the socket connector as shown in FIG. 1;

FIG. 4 is an exploded, perspective view of the socket connector as shown in FIG. 1;

FIG. 5 is a sectional view showing a cover is to be mounted on a base while a contact keeps with a linear configuration; and

FIG. 6 is a side view of the socket connector as shown in FIG. 1, showing the contact is bent as the cover is mounted downwardly.

### DETAILED DESCRIPTION OF THE INVENTION

Reference will now be made to the drawings to describe the present invention in detail.

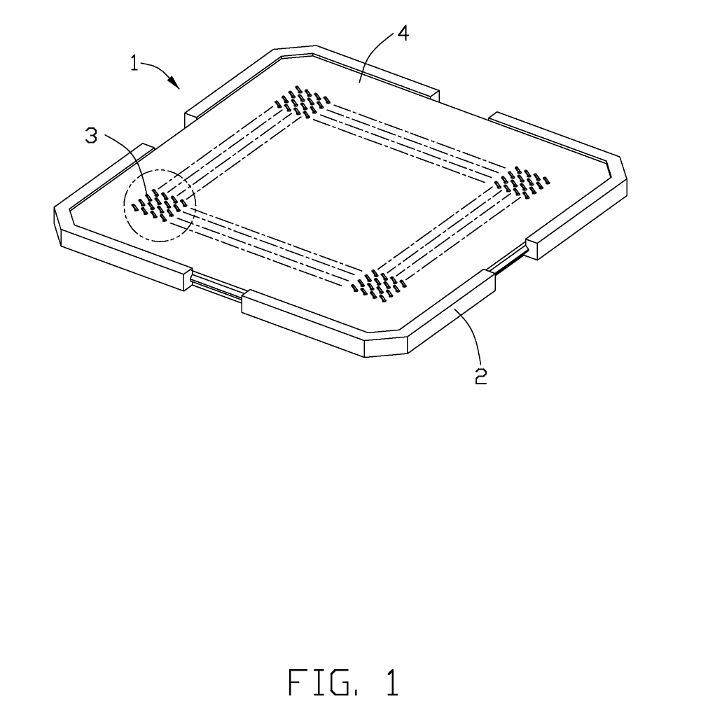

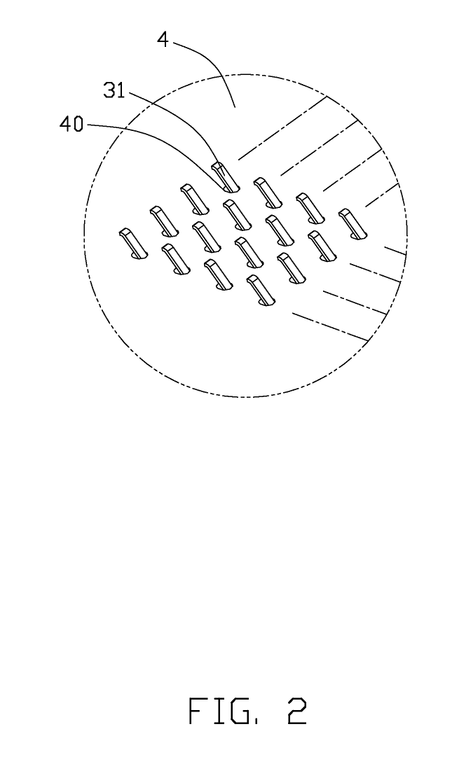

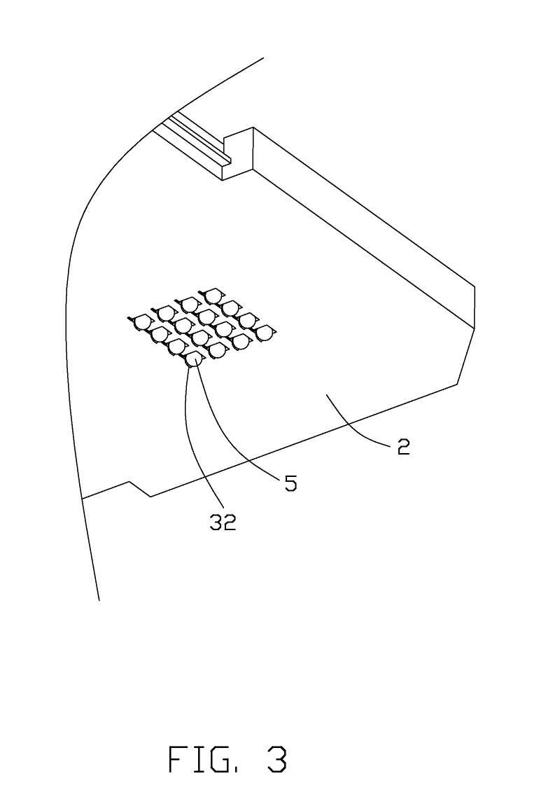

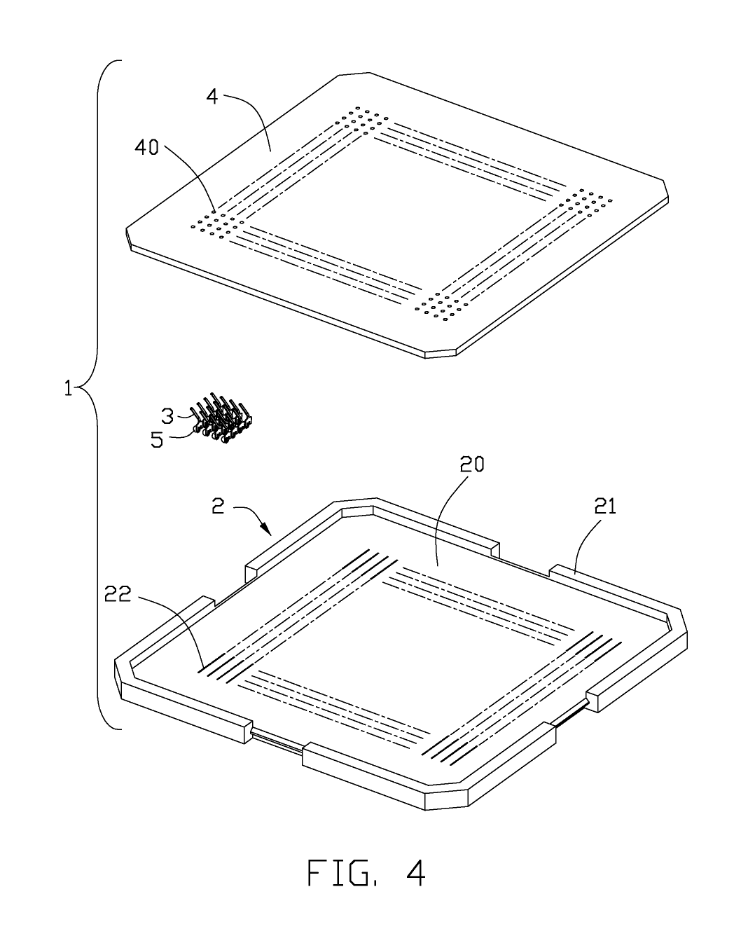

Referring to FIG. 1 to FIG. 5, a socket connector 1 made in accordance with the present invention is provided to interconnect between an electronic package (not shown) and a motherboard (not shown). The socket connector 1 includes a socket body 2, a plurality of contacts 3 retained in the socket body 2, and a cover 4 located above the socket body 2.

The socket body 2 includes a base 20 and a plurality of periphery sidewalls 21 extending upwardly from the base 20. The base 20 and the sidewalls 21 jointly define a receiving space for accommodation of the cover 4. The base 20 has a plurality of passageways 22 for retaining the contacts 3. Each contact 3 includes a base portion 30, a slanting resilient arm 31 extending upwardly and obliquely, and a holding portion 32 extending downwardly. A cavity 23 is formed at a bottom surface of the socket body 2 and is communicated with the passageway 22. A solder ball 5 is partially received in the cavity 23, and the holding portion 32 extends into the cavity for retaining the solder ball 5.

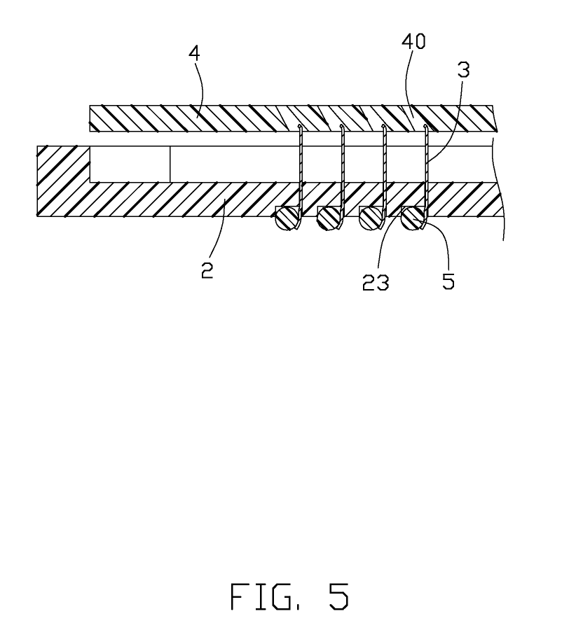

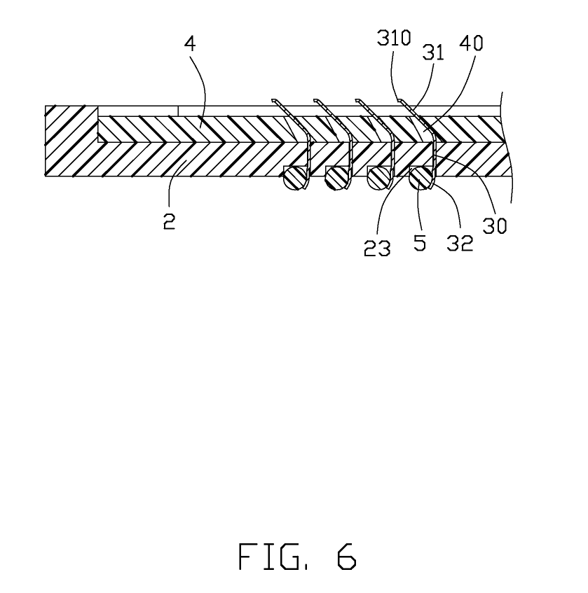

The cover 4 is formed with a plurality of slanting through holes 40, and the resilient arms 31 of the contacts are respectively inserted into and extending along the through holes 40. A contacting end 310 of the resilient arm 31 extends beyond an upper surface of cover 4 to mate with an electronic package. The through hole 40 has an upper smaller opening and a lower bigger opening, and thus has a trapezoid side view. Particularly referring to FIG. 5 to FIG. 6, before the cover 4 is mounted to the socket body 2, the contact 3 is inserted into socket body 2 and stands upright with a linear configuration. As the cover 4 is moved toward the socket body 2, the linear contact 3 engages the slanting inner surface of the through hole 40 and deflects in correspondence with the structure of the inner surface of the through hole 40. When this mounting process is completed, the contact 3 is deformed to a predetermined state as shown in the FIG. 6, and the resilient arm 31 abuts against the inner surface of the through hole 40 in a free position where no external pressure is applied.

The horizontal movement of the contacting end 320 and the whole resilient arm 32 are constrained by the through hole 40 and shorting of adjacent contacts 3 is therefore avoided. In addition, when the electronic package is loaded onto the socket connector 1, the resilient arm 32 of the contact 3 is depressed and moved downwardly. However, because of the existence of the slanting through hole 40, the downward movement of the resilient arm 31 is also limited.

While preferred embodiments in accordance with the present invention has been shown and described, equivalent modifications and changes known to persons skilled in the art according to the spirit of the present invention are considered within the scope of the present invention as defined in the appended claims.

1. A socket connector, comprising:
a socket body;
a cover located above the socket body; and
a plurality of contacts each having a base portion retained in the socket body and a resilient arm extending upwardly from the base portion;
wherein when the cover is in a free position, the resilient arm is essentially upright; when the cover is pressed downwardly, the resilient arm is pressed to have an angle with the base portion.

2. The socket connector as claimed in claim 1, wherein the cover is formed with a plurality of slanting through holes through which the resilient arm of the contacts extends.

3. The socket connector as claimed in claim 2, wherein the through hole of the cover has a smaller upper opening and a bigger lower opening.

4. The socket connector as claimed in claim 1, further comprising a solder ball received in a cavity formed at a bottom surface of the socket body, and wherein the contact has a holding portion extending into the cavity and securely holding the solder ball in the cavity.

5. The socket connector as claimed in claim 1, wherein the socket body comprises a base and a periphery sidewalls extending upwardly from the base, the base and the sidewalls jointly defining a receiving space for accommodation of the cover.

6. The socket connector as claimed in claim 2, wherein the resilient arm of the contact abuts against an inner surface of the through hole when in a free position.

7. A socket connector, comprising:
a socket body;
a cover located above the socket body and having an upper surface, a lower surface and a plurality of through holes penetrating the upper surface and the loser surface; and
a plurality of contacts each having a base portion retained in the socket body and a resilient arm extending upwardly from the base portion with a contacting end at the fee end thereof;
wherein when the cover is in a free position, the resilient arm is in a same plane with the base portion, when the cover is pressed downwardly, the resilient arm is pressed to abut against an inner wall of the through hole and slide along the inner wall to make the contacting end locate beyond the upper surface of the cover.

8. The socket connector as claimed in claim 7, wherein the contact has a contacting end extending beyond an upper surface of the cover.

9. The socket connector as claimed in claim 7, wherein the through hole of the cover has a smaller upper opening and a bigger lower opening.

10. The socket connector as claimed in claim 7, further comprising a solder ball received in a cavity formed at a bottom surface of the socket body, and wherein the contact has a holding portion extending into the cavity and securely holding the solder ball in the cavity.

11. The socket connector as claimed in claim 7, wherein the socket body comprises a base and a periphery sidewalls extending upwardly from the base, the base and the sidewalls jointly defining a receiving space for accommodation of the cover.

12. The socket connector as claimed in claim 7, wherein the resilient arm of the contact abuts against an inner surface of the through hole when in a free position.

13. An electrical connector comprising:
an insulative housing defining a receiving space;
a cover up and down moveable in the receiving space and defining therein a plurality of oblique through holes between opposite upper and bottom faces thereof; and
a plurality of contacts each having a lower section retained within the housing and an upper section located above an upper surface of the housing and extending through the corresponding through hole beyond the upper face; wherein
the upper section is downwardly deflected by the cover to extend obliquely along a direction defined by the corresponding through hole; wherein
said oblique through holes are laterally segregated from one another between the upper and bottom faces without lateral communication therebetween.

14. The electrical connector as claimed in claim 13, wherein the upper section is upright before extends into the corresponding through hole.

15. The electrical connector as claimed in claim 13, wherein the closer the cover is moved toward the housing, the more the contact experiences downward deflection.

16. The electrical connector as claimed in claim 13, wherein the upper section exposed above the upper face, is preloaded for efficiently contacting an electronic package located upon the upper face.

17. The electrical connector as claimed in claim 13, wherein the receiving space is dimensioned larger than the cover in a vertical direction for further enclosing an electronic package which is seated upon the upper face of the cover.

18. The electrical connector as claimed in claim 13, wherein each of said through holes defines an oblique inner surface which terminates between the upper and bottom faces of the cover and against which the upper section of the corresponding contact abuts except a lower portion of said oblique inner surface.

19. The electrical connector as claimed in claim 15, wherein the closer the cover is moved toward the housing, the more a deflection length of the upper section increases.
